(19) United States
(12) Patent Application Publication
(10) Pub. No.: US 2013/0270141 A1
(43) Pub. Date: Oct. 17, 2013

(54) FLUID LEAKAGE DETECTION DEVICE

(71) Applicants: Stephen Bruce Anderson, SR., Chester, VA (US); William Preston Burton, JR., Newport News, VA (US)

(72) Inventors: Stephen Bruce Anderson, SR., Chester, VA (US); William Preston Burton, JR., Newport News, VA (US)

(73) Assignee: BOWL BEAVER, LLC, Newport News, VA (US)

(21) Appl. No.: 13/444,412

(22) Filed: Apr. 11, 2012

(51) Int. Cl. B65D 85/00; G01D 13/00

(52) U.S. Cl. 206/459.1; 116/200

(57) ABSTRACT

A device for the detection of the fluid leakage of utilities or appliances includes a waterproof dam sheet and a moisture indicator. The moisture indicator includes two sheets, between which there is an absorbent gauze strip containing a water soluble dye. Each of the two sheets further comprises a clear sealed indication area for viewing the detection results. The moisture indicator may include a smart moisture sensor which continuously measures relative humidity of the utility or appliance. The smart moisture sensor connects with a network to provide a real time alarm and notification to any predefined recipients via email, a cell phone, or other communication device when the humidity increases beyond a preset threshold.

### BACKGROUND OF THE INVENTION

The present invention relates generally to a device and system for detecting and/or indicating a fluid leak, such as, for example, a device that identifies fluid leakage of a toilet.

Fluid leakages, especially leakages over time, may cause substantial damage to homes and businesses and result in time-consuming and expensive repair. Some fluid leakages need to be detected very early for adequate protection and response. However, most fluid leakage is stealthy and hard to detect in a timely manner. For example, minor leaks in and around valves in both old and modern hot water radiators when the fluid flow is adjusted or when the radiator is aired for adjustment. And, leakages in pipe joints, couplings, and fittings to household appliances, such as dish washers, washing machines, ice makers, and others may be difficult to detect, especially when built into a cabinet or otherwise hidden.

Leaks can take the form of drops, droplets, fine spray or mist of liquids, liquid films, and streams of liquids. Even condensation on pipes may cause moisture damage to surrounding surfaces. Frequently, minor leaks and condensation are not discovered until secondary damage is evident making the extent of the repair greater and more expensive.

Accordingly, it would be desirable to have a detection device to detect and/or indicate the fluid leakages of pipes, utilities and/or appliances to avoid the serious damage caused by long term leakages.

### SUMMARY OF THE INVENTION

The aforementioned problems, and other problems, are reduced, according to exemplary embodiments of the invention, by a fluid detection device allowing manual or automatic detection and/or indication of the fluid leakage of a pipe, utility and/or appliance, such as, for example, the fluid leakage of a toilet. The fluid detection device includes a waterproof dam sheet and a moisture indicator. As an exemplary embodiment, in order to detect and/or indicate the fluid leakage of a toilet, the dam sheet is placed on the floor under the toilet and the moisture indicator is placed at a proximate edge of the toilet bottom.

In an exemplary embodiment, a moisture indicator of the fluid detection device comprises two portions of flat sheets, between which there is an absorbent gauze strip containing a water soluble blue dye. The blue dye is not sensitive to ambient humidity and the distinct color formed is resistant to being washed off or diluted in cases of abundant or repeated leakage. Each of the two portions of the sheets further has a clear sealed indication area for viewing the distinct color caused by liquid leakage.

In another exemplary embodiment, a moisture indicator comprises a smart moisture sensor connecting with a communications network (e.g. Smart Home Grid, Intranet, or cell phone) to provide real time alarming and/or notification. The smart moisture sensor continuously measures relative humidity of a utility or appliance. When the humidity increases beyond a preset threshold, an alert is communicated to any pre-defined recipients through an email notification, a call or electronic message to a cell phone, etc. Such a leak detection system also works with any security or building automation system, and the communication detecting the leak could be sent to a home or business monitoring service.

### BRIEF DESCRIPTION OF THE FIGURES

The accompanying drawing figures, which are incorporated in and form a part of the specification, illustrate embodiments of the present invention, and, together with the description, serve to better explain the principles of the invention. It is to be noted that the figures illustrate only typical embodiments of the invention and are therefore not to be considered limiting of its scope, for the invention will admit to other equally effective embodiments.

FIG. 1 is a perspective view of a fluid detection device in accordance with a preferred embodiment of the present invention;

FIGS. 2A-2E are a top view, bottom view, front view, back view and right side view, respectively, of a dam sheet in accordance with the present invention;

FIG. 3 is a perspective view of a moisture indicator in accordance with the present invention;

FIGS. 4A-4F are a top view, bottom view, front view, back view, right side view and left side view, respectively, of a moisture indicator in accordance with the present invention;

FIGS. 5A-5C illustrate a sequence of steps in the installation procedure for a fluid detection device in accordance with the present invention;

FIG. 6 is a perspective view of a liquid detection device with a smart moisture sensor in accordance with an alternate embodiment of the present invention;

FIG. 7A is a perspective view of a septic tank with a fluid detection device according to the invention; and

FIG. 7B is a plan view of the leakage indicator for the detection device shown in FIG. 7A.

### DETAILED DESCRIPTION

This invention will now be described more fully hereinafter with reference to the accompanying drawings, in which exemplary embodiments are shown. This invention may, however, be embodied in many different forms and should not be construed as limited to the embodiments set forth herein. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or perspective views illustrating some of this invention. The functions of the various elements shown in the figures may vary in shape, attachment, size, and other physical features. Those of ordinary skill in the art further understand that the exemplary systems, and/or methods described herein are for illustrative purposes and, thus, are not intended to be limited to any particular named manufacturer or other relevant physical limitation (e.g., material).

For the purposes of this description, a toilet is used as an exemplary utility to which the fluid detection device applies, though the present invention applies to alternate embodiments including but not limited to toilets, septic tanks, and other utilities or appliances.

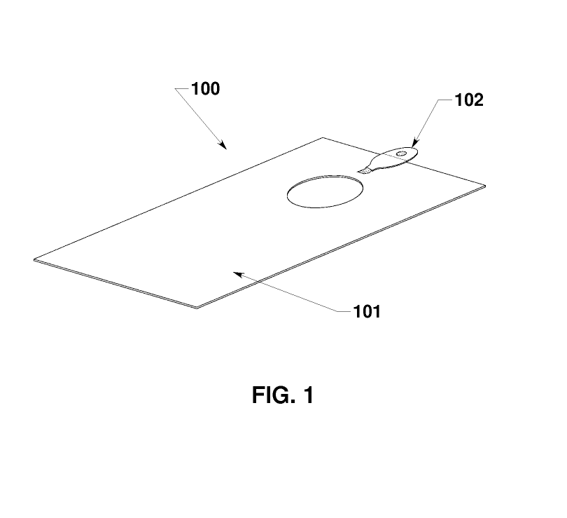

FIG. 1 illustrates a perspective view of a liquid detection device 100 in accordance with an exemplary embodiment of the present invention. The fluid detection device 100 includes a flexible dam sheet 102 and a moisture indicator 104.

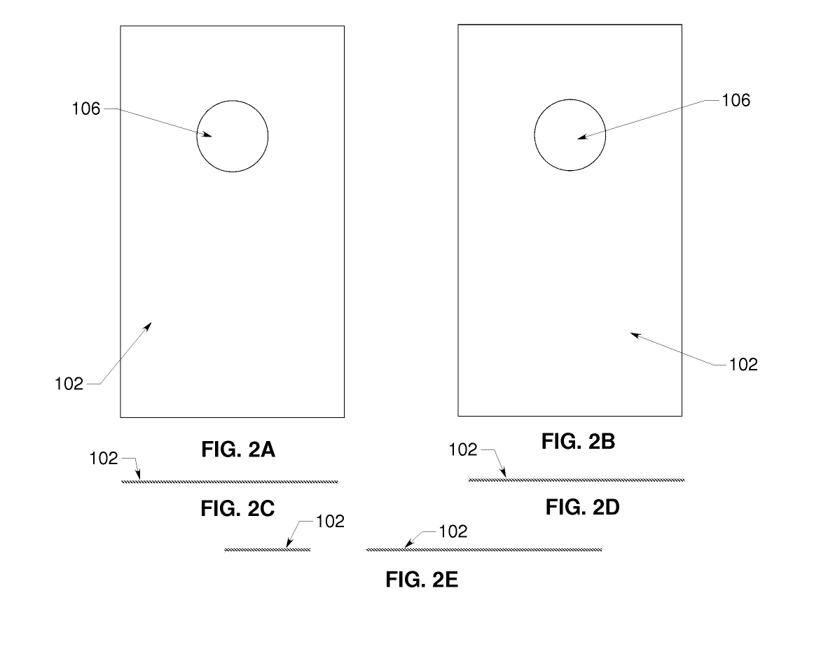

FIGS. 2A-2E illustrate a top view, bottom view, front view, back view and right side view, respectively, of the dam sheet 102 in accordance with a preferred embodiment of the present invention. An aperture 106 in the dam sheet 102 is particularly designed for the usage of toilets. The dam sheet 102 is placed on top of the closet flange of a toilet, so the diameter of the aperture 201 is the same as the diameter of the closet flange. The dam sheet 102 is made of a proprietary synthetic plastic material that prevents water from damaging a floor and which is impervious to cleaning solutions.

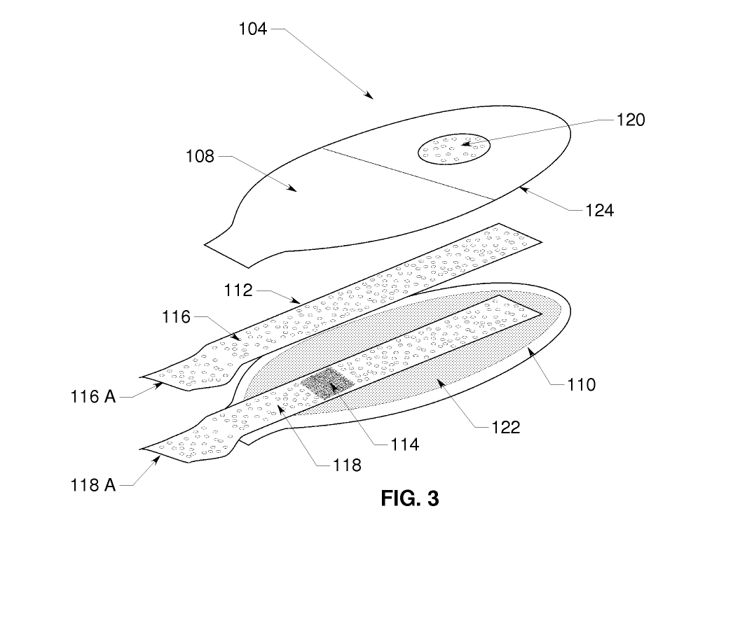

FIG. 3 is an exploded perspective view of a moisture indicator 104 in accordance with a preferred embodiment of the present invention. The moisture indicator 104 is assembled from two relatively rigid synthetic plastic sheets 108 and 110, between which is an absorbent gauze strip 112 containing a specially formulated and water soluble dye 114. In a preferred embodiment, a pair of gauze strips 116 and 118 is provided, with the dye 114 being arranged between the strips. End portions 116A and 118 A of the strips extend beyond the plastic sheets as shown. The dye 114 is not sensitive to normal ambient humidity and the distinct color formed by the dye is resistant to being washed off or diluted in cases of abundant or repeated leakage. When water or other fluid is present, it wicks into the gauze strips of the moisture indicator 104, picking up the dye 114 and transferring it to a clear sealed indication area 120 of each plastic sheet 108, 110 for viewing by the user. The components of the moisture indicator are bonded together with a layer of adhesive 122. A guide line 124 may be printed on the surface of each synthetic plastic sheet 108, 110 to assist with proper placement of the indicator 104 during assembly. The dye is preferably a pigmented water soluble granulized powder typically used in the food and beverage industry. The powder preferably contains additives to maintain a color hue for a period of up to six months after being activated by water. The powder is chemically known as a disodium salt. Although any color may be used, by way of example only, the present invention utilizes a blue dye.

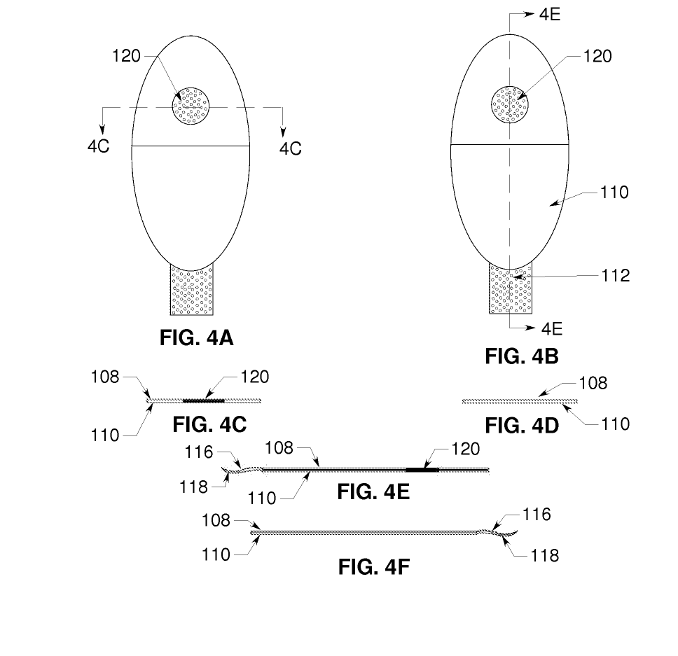

FIGS. 4A and 4B are top and bottom views of the moisture indicator 104 of FIG. 3 in an assembled condition. As shown therein, a clear indication area 120 is provided in each of the top 108 and bottom 110 sheets, with the gauze 112 extending from one end of the indicator. The clear sealed indication area 120 of the moisture indicator allows users to detect the distinct color caused by the presence of liquid.

FIG. 4C is a sectional view of the moisture indicator taken along line 4C-4C of FIG. 4A and showing the gauze strip 112 between the sheets. FIG. 4D is a bottom view of the moisture indicator. FIG. 4E is a sectional view of the moisture indicator taken along line 4E-4E of FIG. 4B. FIG. 4F is a left side view of the moisture indicator.

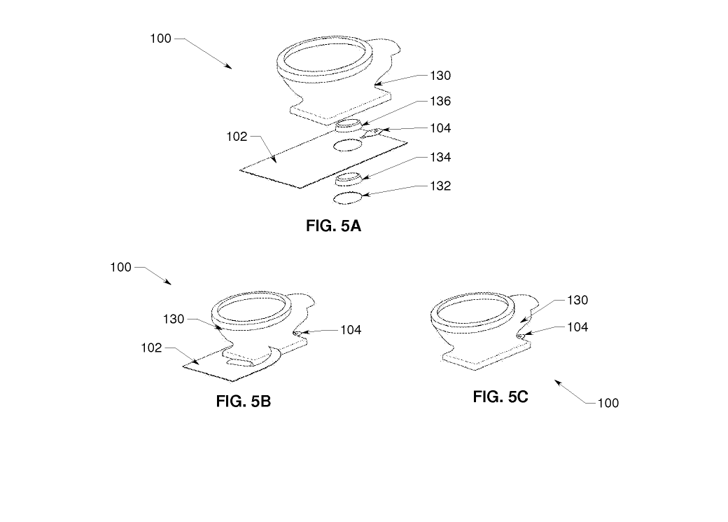

FIGS. 5A-5C illustrate the sequence of steps for installing a fluid detection device 100 according to the invention beneath a toilet 130 in accordance with some a preferred embodiment of the present invention. First, the toilet 130 is removed, and then old wax needs to be removed from the bottom of the toilet 130 and closet flange 132. Thereafter, a wax ring 134 is placed on the closet flange 132 for a double ring installation instead of a single ring installation. Next, the dam sheet 102 of the liquid detection device 100 is placed on the floor with the long end towards the front of the toilet bowl. After the placement of the dam sheet 102, a second wax ring 136 is placed on the sheet above the closet flange 132. The moisture indictor 104 is placed at the rear of the toilet 130 and adjusted so that the indicator line 124 (FIG. 3) is under the edge of the toilet 130. Next, the bowl of the toilet 130 is set in place. Finally, as shown in FIG. 5B, the excess material of the dam sheet 102 is trimmed from around the bowl of the toilet, and the toilet is sealed to the floor in a conventional manner, typically by applying a bead of silicone. Through the above steps, the liquid detection device 100 is installed beneath the toilet 130 as shown in FIG. 5C.

One added benefit to use of the liquid detection device according to the invention is that early detection of fluid leaks around a toilet can prevent significant damage to a household and provide certain health benefits because of the damage and harm done by leaking feces and urine. If there is a leak in the seal beneath a toilet, effluent from the toilet will be mixed with the water. Over time, the effluent can cause significant damage as it seeps into the floor beneath the toilet. This results in the formation of black mold and other harmful pathogens. Typically, the damaged material must be removed using bio-hazard techniques and then packaged and disposed of as medical waste. Early detection of a leak will prevent such damage and the increased costs associated therewith. It will also facilitate compliance with local plumbing codes for toilet installations.

The above described embodiments are directed towards a leak detection device to detect leaks from a toilet; however, as one of ordinary skill in the art recognizes, the leak detection device can be adapted to detect leaks from other utilities (e.g., showers, sinks, etc.), appliances (e.g., dishwasher, washing machine, ice maker, freezer, etc.), radiators, hot water heaters, and/or areas surrounding pipes.

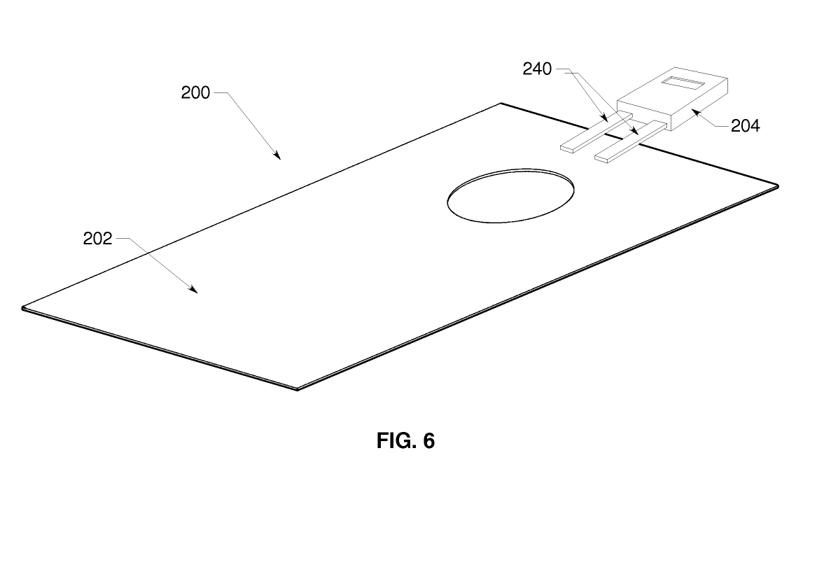

FIG. 6 illustrates an alternate embodiment for a liquid detection device 200 with a smart moisture sensor 202. The liquid detection device 200 includes a dam sheet 202 and a smart moisture sensor 204. Connectors 240 connect the sensor 204 with the dam sheet. The smart moisture sensor 204 continuously measures relative humidity of a utility or appliance. It connects with a network to provide a real time alarm and notification. When the humidity increases beyond a preset threshold, an alert is sent to any pre-defined recipients via email, cell phone or other communication system. The smart moisture sensor 204 works with any security or building automation system.

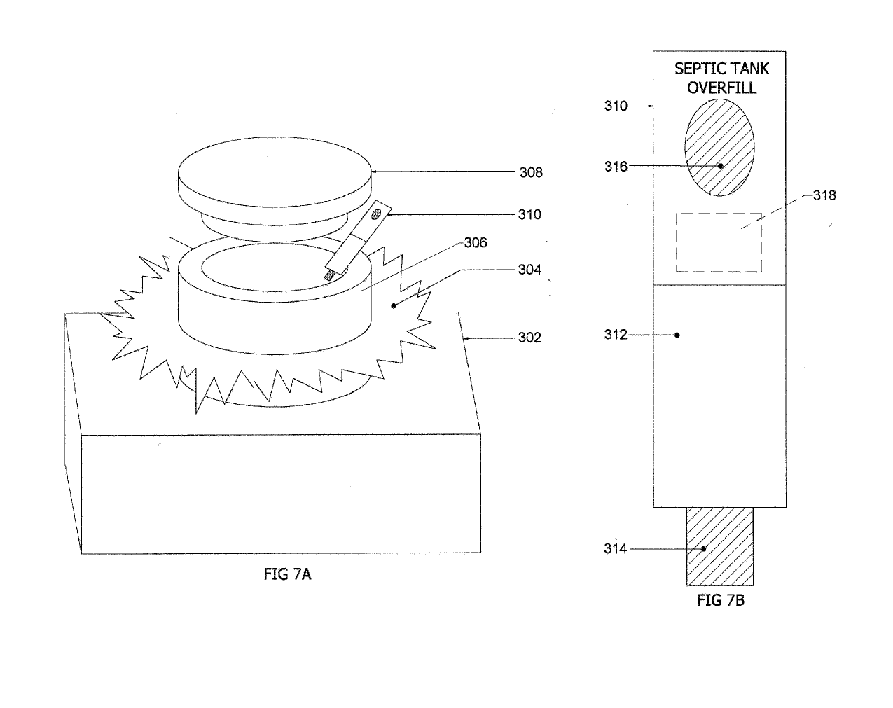

FIGS. 7A and 7B illustrate an alternate embodiment of the invention used to indicate that a septic tank is full. Referring first to FIG. 7A, a septic tank 302 is buried beneath the surface of the ground 304. A neck portion 306 of the tank extends above the ground and is closed by a lid 308. A moisture indicator 310 according to the invention is arranged between the lid and the neck portion. As shown in FIG. 7B, the moisture indicator is similar to the indicator 104 of FIGS. 3 and 4 except that it is larger and can be formed of more durable materials since it is used in an exterior environment. The indicator includes a relatively rigid synthetic plastic sheet 312 with a gauze strip 314 arranged therein and extending from a lower end thereof. The gauze strip extends the length of the sheet beneath a clear viewing area 316. A dye material 318 is arranged in the gauze strip.

The lower end of the indicator 310 having the gauze strip 314 extending therefrom is arranged in the tank. The remaining portion of the indicator extends beyond the lid. When fluid within the tank reaches the top of the tank, it engages the gauze and wicks through the gauze to intersect the dye. Continued wicking of the fluid and die is visible in the viewing area 316 to indicate that the tank is full.

While the invention has been particularly shown and described with references to a preferred embodiment thereof, it will be understood by those skilled in the art that various changes in form and details may be made therein without departing from the spirit and scope of the invention. For example, each component of a liquid detection device may be made by alternative materials and may have alternative shapes and sizes. And the dam sheet and moisture indicator of the liquid detection device may be placed at any alternative location for a specific detection as well.

What is claimed is:

1. A device for the detection of fluid leakage comprising:
at least one dam sheet; and
a moisture indicator.

2. The device of claim 1, wherein the dam sheet comprises a waterproof plastic.

3. The device of claim 1, wherein the moisture indicator comprises a pair of sheets, an absorbent gauze strip arranged between said sheets, and a fluid soluble material in a portion of said gauze strip, said fluid soluble material forming a distinct color when activated by a fluid.

4. The device of claim 3, wherein said fluid soluble material comprises a dye.

5. The device of claim 4, wherein said dye comprises a granulized powder formed of a disodium salt.

6. The device of claim 3, wherein each of said pair of sheets includes a clear sealed indication area for viewing the absorbent gauze strip.

7. The device of claim 3, wherein each said pair of sheets is formed of a liquid-proof plastic.

8. The device of claim 1, wherein the moisture indicator comprises a smart moisture sensor for measuring relative humidity.

9. Apparatus for indicating a fluid level in a septic tank having a neck portion connected with the tank and a lid for closing the neck portion, comprising a fluid detection device including
a. a pair of sheets of flexible waterproof material;
b. an indicator connected with said pair of sheets;
c. a strip of gauze material arranged between said pair of sheets and extending at least to said indicator, a portion of said gauze material extending beyond said pair of sheets at one end; and
d. a fluid soluble dye material connected with said strip of gauze material, whereby said fluid detection device is arranged between said septic tank lid and said neck portion with said gauze material extending into said neck portion and said indicator arranged exterior of said tank to indicate when fluid within said tank reaches said neck area to engage said gauze, said fluid being wicked by said gauze to intercept said dye material to provide an indication at said indicator that the septic tank is full of fluid.

10. Apparatus as defined in claim 9, wherein said dye material comprises a granulized powder formed of a disodium salt.

11. Apparatus as defined in claim 10, wherein said sheets are formed of a fluid-proof synthetic plastic material.
